(19) United States
(12) Patent Application Publication
(10) Pub. No.: US 2012/0050024 A1
(43) Pub. Date: Mar. 1, 2012

(54) VEHICLE CAMERA SYSTEM

(75) Inventors: RONALD M. TAYLOR, GREENTOWN, IN (US); YEW KWANG LOW, SINGAPORE (SG); KOK WEE YEO, SINGAPORE (SG)

(73) Assignee: DELPHI TECHNOLOGIES, INC., TROY, MI (US)

(21) Appl. No.: 12/868,030

(22) Filed: Aug. 25, 2010

(51) Int. Cl. B60Q 1/00

(52) U.S. Cl. 340/435

(57) ABSTRACT

A vehicle camera system having features to attract the attention of a vehicle driver for discerning an object about the vehicle. The vehicle camera system has a camera configured to view an area about a vehicle and an infrared sensor configured to detect an object at a location within the area. The system includes a display that shows an image of the area and highlights a portion of the display corresponding to the location of the object when the object is detected by the infrared sensor. The infrared sensor is formed by a non-planar arrangement of infrared detectors that provides a wide angle field of view for detecting objects radiating infrared energy, without sacrificing infrared detection sensitivity.

### TECHNICAL FIELD OF INVENTION

The invention generally relates to a vehicle camera system displaying an image of an area about the vehicle to a vehicle operator, and more particularly relates to a using an infrared detector to detect an object at a location within the area and highlighting a portion of the display corresponding to the location when the object is detected.

### BACKGROUND OF INVENTION

It is known to use a camera to capture a view of an area about a vehicle and display an image of the area to a vehicle operator. Some such cameras are directed rearward of the vehicle to provide an image of the area behind the vehicle that shows a larger area than is available using rearview minors. Also, some such cameras are directed along the side of the vehicle to provide an image of the area along side the vehicle that includes the area known as the blind spot. A known problem for such vehicle camera systems is that the wide range of ambient lighting and reflectivity makes it difficult for a vehicle operator looking at a display to discern the object.

### SUMMARY OF THE INVENTION

The difficulty that a vehicle operator has with discerning an object on a camera system display showing an image of an area viewed by a camera is solved by using an infrared sensor to detect an object at a location within the area and highlighting a portion of the display that corresponds to the location detected by the infrared sensor when the object is detected.

In accordance with one embodiment of this invention, a vehicle camera system is provided. The vehicle camera system includes a camera, an infrared sensor, and a display. The camera is configured to view an area about a vehicle. The infrared sensor is configured to detect an object at a location within the area. The display is configured to display an image of the area and highlight a portion of the display corresponding to the location when the object is detected.

In another embodiment of the present invention, a controller for a vehicle camera system is provided. The controller is configured to receive a camera signal from a camera configured to view an area about a vehicle and receive an infrared sensor signal from an infrared sensor configured to detect an object at a location within the area. The controller is also configured to output a display signal to a vehicle operator display. The display signal is indicative of an image of the area and highlights a portion of the display corresponding to the location when the object is detected.

In yet another embodiment of the present invention, a method for displaying an image from a vehicle camera is provided. The method includes the steps of receiving a camera signal from a camera configured to view an area about a vehicle and displaying an image of the area about the vehicle on a display. The method also includes the steps of receiving an infrared sensor signal from an infrared sensor configured to detect an object at a location within the area and highlighting a portion of the display corresponding to the location. Highlighting occurs when the object is detected.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a top view of a vehicle equipped with a vehicle camera system in accordance with one embodiment;

FIG. 2 is a cutaway perspective interior view of the vehicle of FIG. 1 in accordance with one embodiment;

FIG. 3 is an end view of an arrangement of a camera and an infrared sensor of the vehicle camera system of FIG. 1 in accordance with one embodiment;

FIG. 4 is a top view of a vehicle equipped with a vehicle camera system of FIG. 3 in accordance with one embodiment;

FIG. 5 is a cutaway perspective interior view of the vehicle of FIG. 4 in accordance with one embodiment;

FIG. 6 is a block diagram of the vehicle camera system of FIG. 4 in accordance with one embodiment;

FIG. 7 is a flowchart of a method of operating the vehicle camera system of FIGS. 1 and 4 in accordance with one embodiment;

FIG. 8 is a perspective view of an infrared sensor of the vehicle camera system in accordance with one embodiment; and

FIG. 9 is a top view of a vehicle equipped with a vehicle camera system of FIG. 8 in accordance with one embodiment.

### DETAILED DESCRIPTION OF INVENTION

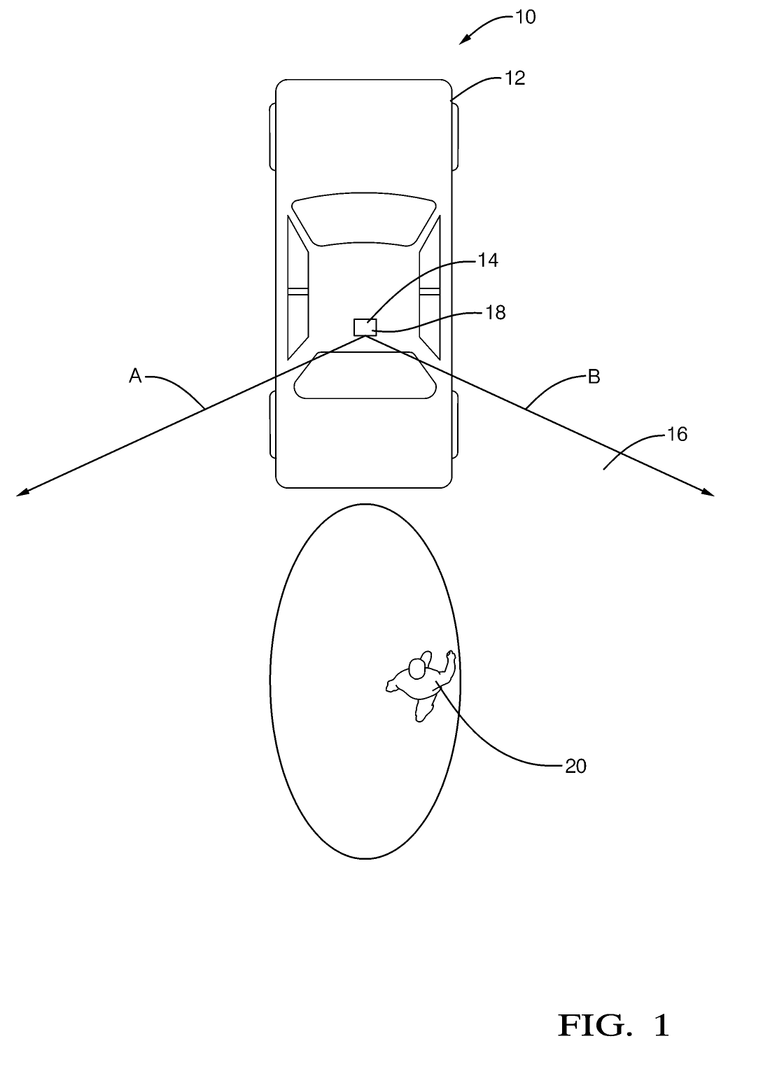

In accordance with an embodiment of a vehicle camera system 10, FIG. 1 illustrates a vehicle 12 equipped with a camera 14. In this non-limiting example, the camera 14 is illustrated as being mounted on the rear end of the roof of the vehicle 12 so that the camera 14 has a view of an area 16 between arrows A and B extending behind the vehicle 12. A typical rearview camera may have a view angle between arrows A and B of 130 degrees. The mounting of the camera 14 may include a housing or other enclosure as should be evident to those in the art. The camera 14 may also be positioned elsewhere on the vehicle, for example, to view an area along side or in front of the vehicle 12. Furthermore, the camera system 10 may have more than one camera, and the system 10 may process signals from multiple cameras to synthesize a composite image of the camera views, such as an image of the entire area surrounding the vehicle 12.

The vehicle camera system 10 may include an infrared sensor 18 configured to detect an object 20, for example a child, at a location 22 within the area 16. The infrared sensor 18 is depicted as being in the same housing as the camera 14. However it should be evident to those skilled in the art that the infrared sensor could be mounted elsewhere, such as on the rear bumper of the vehicle 12.

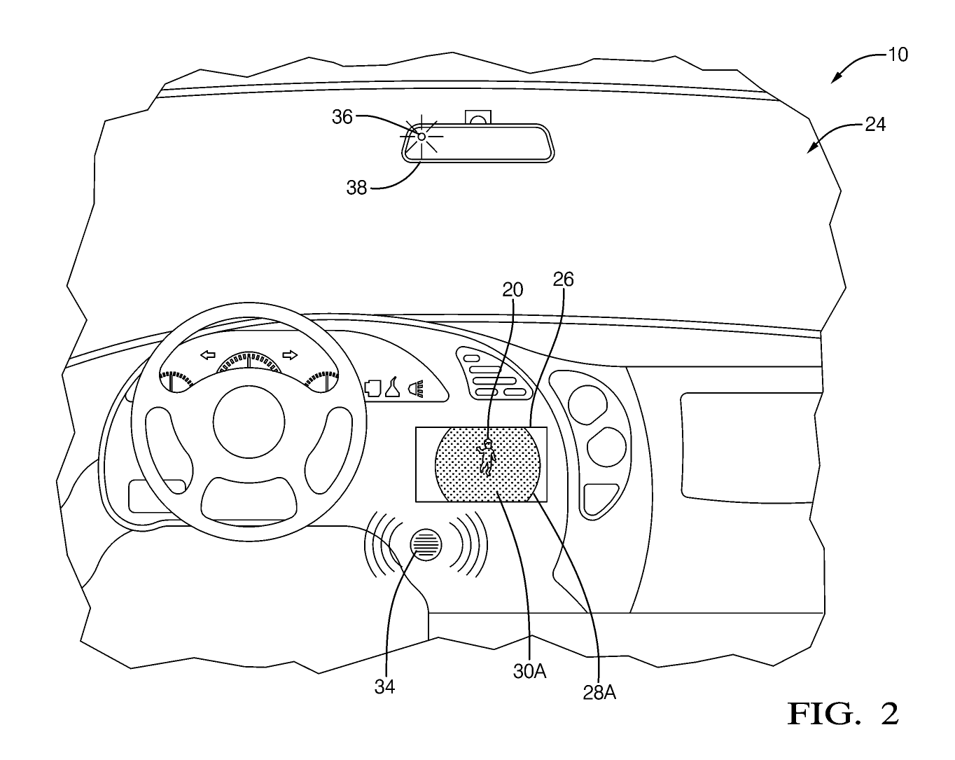

FIG. 2 illustrates an interior 24 of the vehicle 12. The interior 24 includes a non-limiting example of display 26 for displaying an image 28A of the area 16. The camera system 10 is also configured to highlight a portion 30A of the display corresponding to the location 22 detected by the infrared sensor 18 when the object 20 is detected by the infrared sensor 18. By using the detection capability of the infrared sensor 18 to detect the object 20, and then highlight the display 26 accordingly, the attention of the vehicle operator (not shown) can be attracted to the portion of the display highlighted, and so the vehicle operator may more readily discern the presence of the object 20 detected behind the vehicle 12 by the infrared sensor 18.

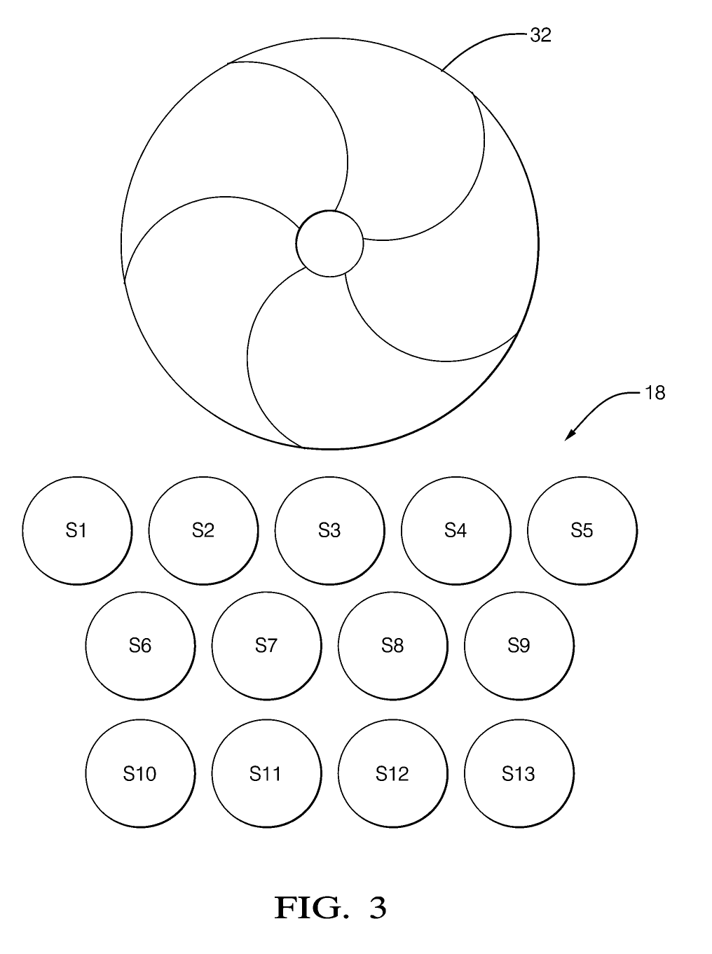

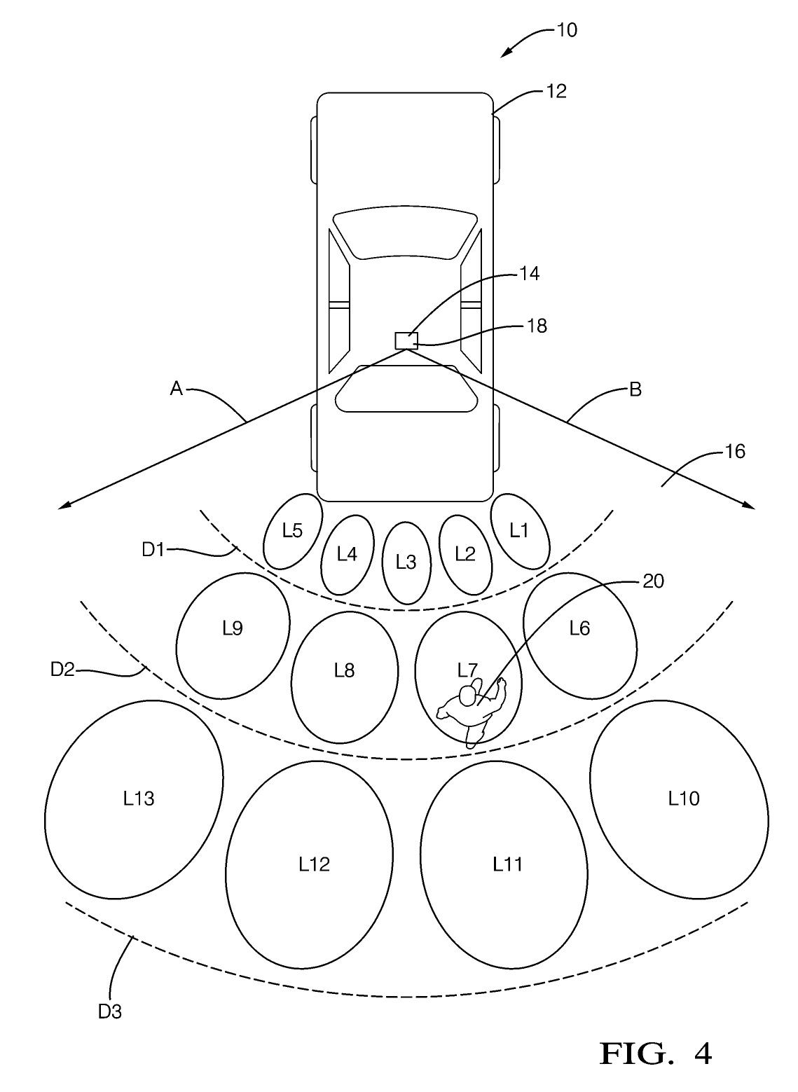

FIG. 3 illustrates a non-limiting example of the infrared sensor 18 being formed of a plurality of infrared detectors S1-S13, such as passive thermopile detectors as described in U.S. Pat. No. 6,753,766 to Patchell, filed Mar. 7, 2001, the entire contents of which are hereby incorporated herein by reference. In general, each infrared detector is focused at a distinct location within the area 16, and so can better determine where an object is within the area 16. In contrast, a single infrared detector can only detect if an object is in location 22 which is substantially the entire area 16. This arrangement of the infrared detectors S1-S13 may be used to detect objects at a plurality of distinct locations L1-L13 within the area 16 as illustrated in FIG. 4. FIG. 3 also illustrates a non-limiting arrangement of a camera aperture 32 for the camera 14 being adjacent to the IR sensor 18, possibly in a single housing as suggested in FIG. 1. Those skilled in the art will recognize that the vehicle camera system 10 may also include a lens (not shown) or a mirror (not shown) to focus infrared light radiating from each of the locations L1-L13 upon the respective infrared detectors S1-S13. Examples of such lenses and minors focusing infrared light on one or more infrared detector are shown in U.S. Pat. No. 7,148,482 to Harter, filed Mar. 25, 2004, and United States Patent Application Publication Number 2006/0067378 by Rege et al, filed May 26, 2005, and 2009/0189752 by Taylor, filed Jan. 25, 2008, the entire contents of which are hereby incorporated herein by reference.

Continuing to refer to FIGS. 3-4, the embodiment of infrared sensor 18 illustrated has a first row of a first number of infrared detectors S1-S5 configured to detect objects less that a first distance D1 from the camera, and a second row of a second number of infrared detectors S6-S9 less than the first number of infrared detectors, said second row of infrared detectors S6-S9 configured to detect objects located between a second distance D2 greater than the first distance D1 and the first distance D1. It is advantageous to have a greater number of infrared detectors focused on smaller locations closer to the vehicle 12 to increase the sensitivity of the infrared detectors S1-S5, while reducing the cost of detecting objects further away from the vehicle 12 by using fewer infrared detectors S6-S9 to cover a larger portion of area 16. Such an arrangement distinguishes the infrared sensor 18 from an infrared camera that would have the same number of detectors (pixels) in each row. As illustrated in FIGS. 3-4, the infrared sensor may include a third row of infrared detectors S10-S13 configured to detect objects at locations L10-13 farther from the camera than the second distance D2 and less than a third distance D3. In this example the second and third rows have the same number of infrared detectors (four). Alternatively, the third row may have fewer infrared detectors than the second row if the sensitivity of the infrared detectors covering the larger areas between the second distance D2 and the third distance D3 is not a problem.

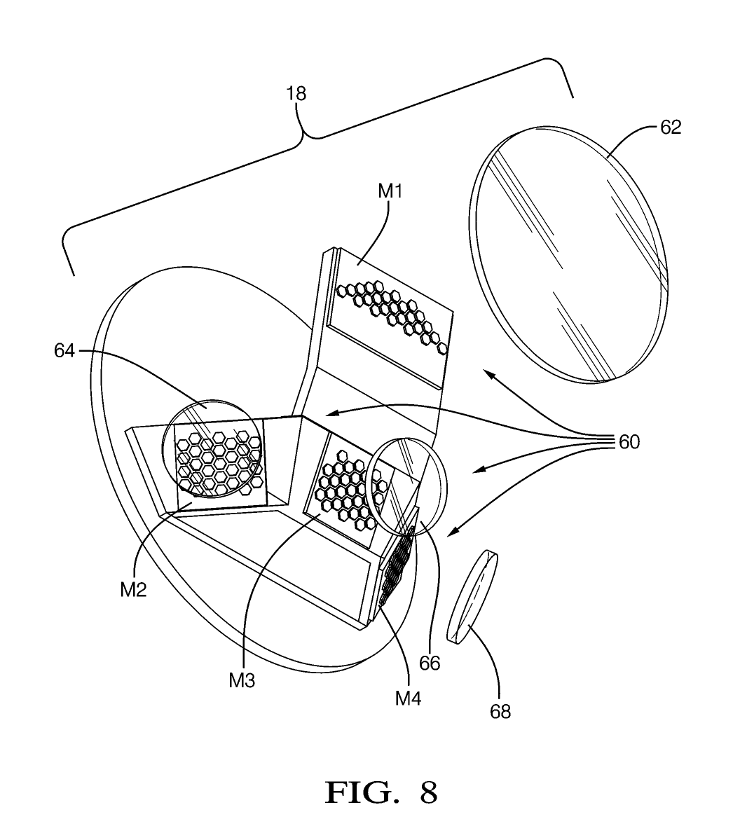

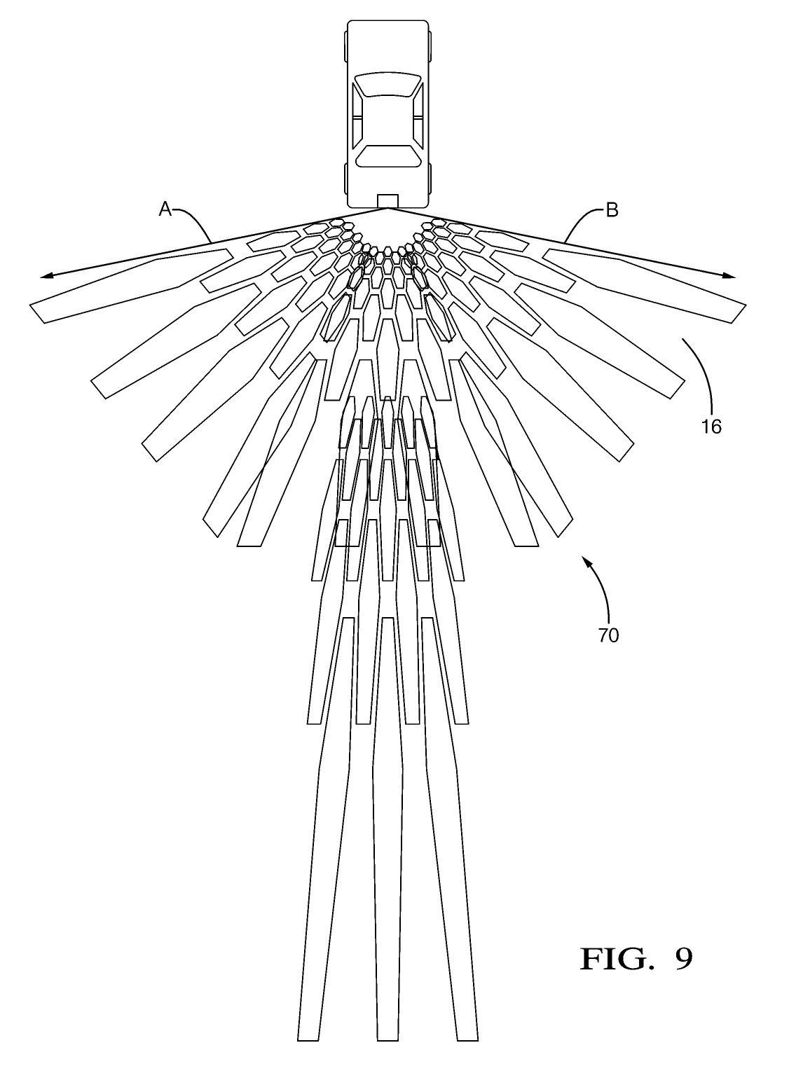

FIG. 8 illustrates another non-limiting example of the infrared sensor 18 being formed of a plurality of infrared detectors 60 arranged to form a plurality of infrared sensor modules M1, M2, M3, and M4. Each sensor module M1-4 may be formed of one or more of the plurality of infrared detectors 60 arranged in planar arrays. The plurality of infrared sensor modules M1-4 may then be arranged in a non-parallel, non-planar arrangement to provide a pattern of locations 70 such as illustrated in FIG. 9. In general, each module M1-4 will have a lens 62, 64, 66, or 68 to focus infrared light radiating from within one of the locations shown in FIG. 9 to one of the infrared detectors 60. It will be appreciated that there are significant optical, efficiency and packaging gains to be realized by the non-planer arrangement of infrared modules for detecting objects in an area 16 having a wide field of view. Advantages for detection sensitivity are realized since for a planar array of detectors focusing radiation off-axis (i.e. toward the edges of the area 16), there is a cosine to the fourth power drop-off in irradiance that becomes increasingly significant as the field angle gets larger. For the backing camera viewing angles (typically around 130 degrees), the signal loss for a planar detector oriented in the same angle can be as much as 95% of the signal that would be focused or collected on-axis. Additionally, the infrared detectors 60 (or S1-S13 in FIG. 3) may be formed to have a hexagonal pixel shape to further increase the packaging density of the detectors. Alternatively, all of the infrared detectors could be arranged so that none of the infrared detectors 60 is co-planar or parallel to any other sensor. However, such an arrangement may be undesirably complicated and expensive to assemble.

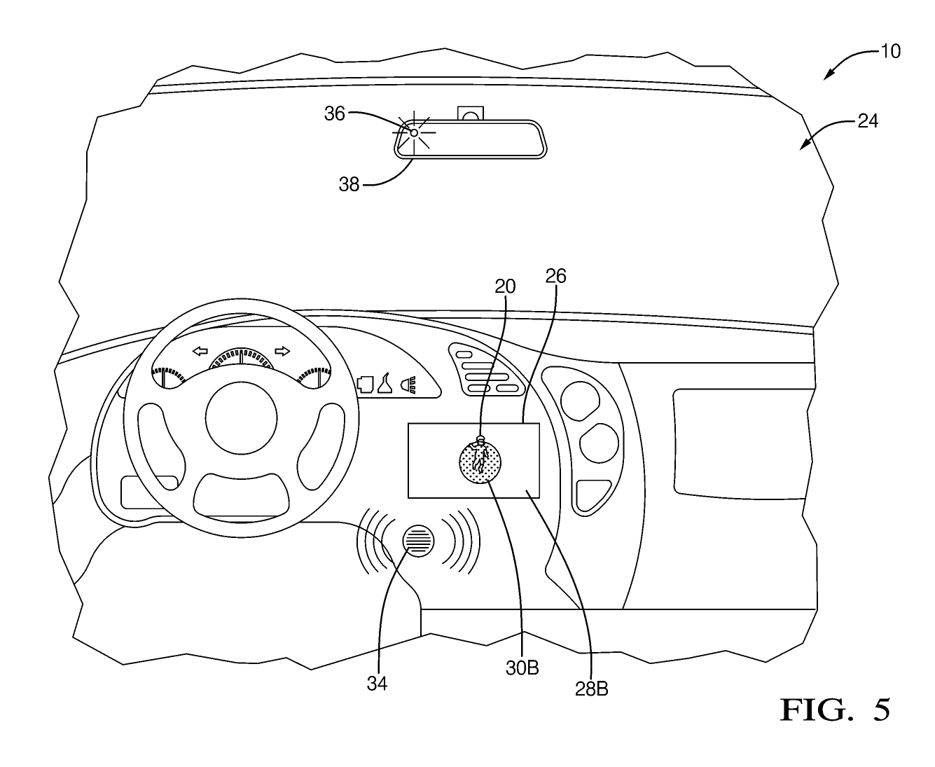

FIG. 5 illustrates a non-limiting example of an image 28B on display 26. In this example, a highlighted portion 30B is illustrated as being smaller than highlighted portion 30A shown in FIG. 2 since the infrared detector S7 is sensing a smaller location L7 as compared to location 22 shown in FIG. 1. Having a smaller highlighted portion is advantageous since the vehicle operator only needs to search a smaller portion of the display to discern the object 20 in the image 28B. While the figures herein depict a single object being detected and a single location on the display 26 highlighted, those skilled in the art will recognize that such a system may be adapted to detect multiple independent objects and highlight multiple independent portions of the display 26.

The vehicle camera system 10 may also include a detection indicator that is activated when the object 20 is detected by the infrared sensor 18. Referring to FIGS. 2 and 5, a suitable detection indicator may be an audible alarm 34 mounted somewhere in the interior so as to be heard by the vehicle operator (not shown) when activated. When the audible alarm 34 is sounded, the vehicle operator will be alerted to inspect the display 26 for the object 20. Alternatively, the detection indicator may be a visual indicator 36 such as a light positioned in a rearview minor 38. By positioning the visual indicator 36 in the rearview minor 38, the attention of the vehicle operator may be readily had as the vehicle operator will likely look at the rearview mirror 38 when backing the vehicle 12. It will be appreciated that the vehicle camera system 10 may include both the audible alarm 34 and the visual indicator 36, and that many other types of detection indicators are available for positioning at a variety of locations.

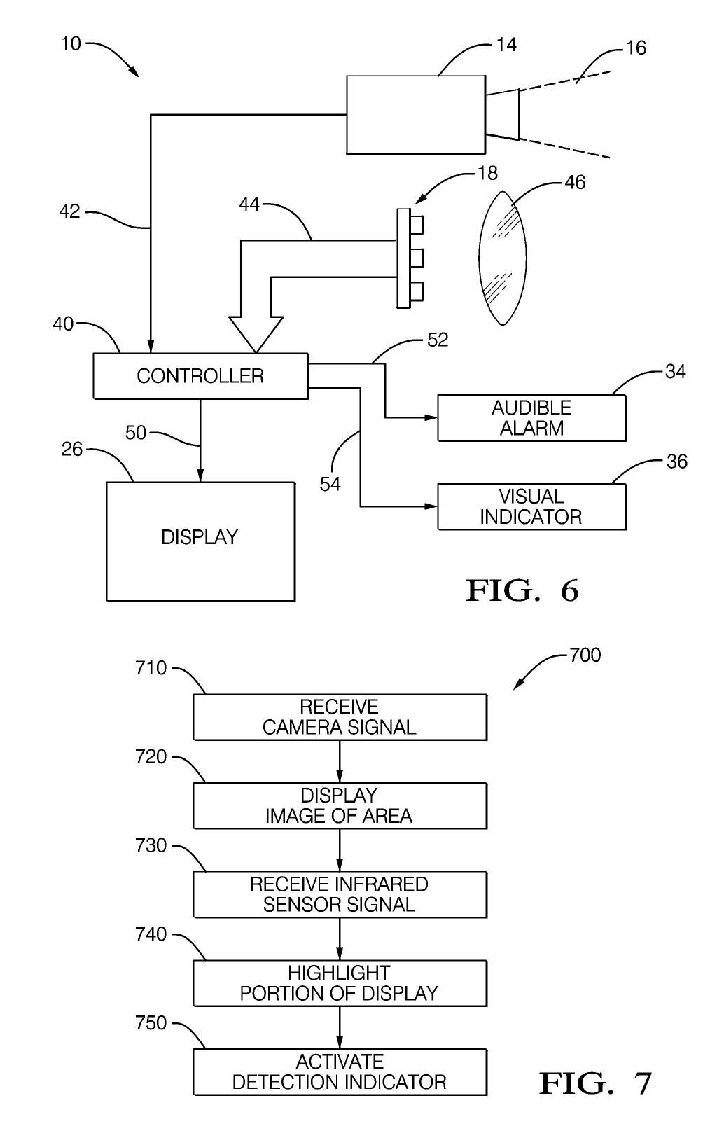

FIG. 6 illustrates a block diagram of a non-limiting example the vehicle camera system 10. A controller 40 is illustrated as part of the system 10. The controller 40 may be configured to receive a camera signal 42 from the camera 14 viewing the area 16 about the vehicle 12, and configured to receive an infrared sensor signal 44 from an infrared sensor 18 configured to detect an object at a location within the area 16. As depicted, the illustration of the infrared sensor suggests a side view of the three rows of infrared detectors illustrated in FIG. 3. The infrared sensor signal 44 may include signals from one or more infrared detectors that may be transmitted to the controller 40 on individual wires, or may be conveyed using a digital signal that includes data for each infrared detector in the infrared sensor 18. The illustration also suggests that the IR sensor includes a lens 46 for focusing infrared light on the infrared detectors forming the infrared sensor 18 as suggested above.

The controller 40 may also be configured to output a display signal 50 to a vehicle operator display 26. The display signal may be indicative of an image of the area 16 and highlighting a portion of the display 26 corresponding to the location detected by the infrared sensor 18 when the object 20 is detected as illustrated in FIGS. 2 and 5. The controller 40 may be further configured to output an audible alarm signal 52 to the audible alarm 34 and/or a visual indicator signal 54 to the visual indicator 36 when an object is detected by the infrared sensor 18.

FIG. 7 illustrates a method 700 for displaying an image from a vehicle camera 14. At step 710, a camera signal 42 may be received by the controller 40 from the camera 14 that is configured to view an area 16 about a vehicle 12. Step 710 may also include receiving a second camera signal (not shown) from a second camera (not shown) configured to view another area (not shown) distinct from the area 16, whereby the controller 40 may combine the separate camera signals to form a single image showing both areas. At step 720, an image of the one or more areas about the vehicle 12 viewed by one or more cameras may be displayed on the display 26.

At step 730, an infrared sensor signal 44 may be received by the controller 40 from the infrared sensor 18 that is configured to detect an object presence of the object 20 at a location within the area 16. Step 710 may also include receiving other infrared signals from other infrared sensors configured to detect objects in other locations inside or outside of the area 16. For example, if the vehicle camera system 10 has a second camera (not shown), then there may be a second infrared sensor configured to detect objects in the area viewed by the second camera.

At step 740, the controller may modify the image signal 50 to highlight the portion 30 of the display corresponding to the location of an object detected by the infrared sensor 18 when the object is detected. The highlighting may be to change the coloring of the image to make the portion 30 more apparent, for example by tinting the portion 30 red. In the case where the display is a black and white type display, the highlighting may take the form of increasing the brightness within the portion 30 relative to the surrounding image, or darkening the surrounding image. In addition, the highlighting may alternate or pulse so as to further attract the attention of the vehicle operator.

At step 750, the controller 40 may output a signal to activate a detection indicator that indicates that an object has been detected by the infrared sensor. The activation signal may be the audible alarm activation signal 52, and/or the visual indicator activation signal 54, as is appropriate for the devices provided for indicating that an object has been detected.

Accordingly, a vehicle camera system 10, a controller 40 for the vehicle camera system 10, and a method 700 of displaying an image from a vehicle camera is provided. An infrared sensor 18 is used to detect the presence of an object 20, and the display showing the image of the view captured by the camera is altered in a way that helps a vehicle operator to more readily identify and/or otherwise classify the object 20. As such the vehicle operator does not need to search the entire image shown on the display 26 to determine that an object is present. The highlighting of a portion 30 of the display may be sufficient to attract the attention of the vehicle operator. Otherwise, the system 10 may include a detection indicator such as an audible alarm or a visual indicator (e.g. a light) to notify the vehicle operator that an object has been detected and the display may need to be examined. The non-planar arrangement of sensor modules provides for a wide area of coverage in a compact package.

While this invention has been described in terms of the preferred embodiments thereof, it is not intended to be so limited, but rather only to the extent set forth in the claims that follow.

We claim:

1. A vehicle camera system comprising:
a camera configured to view an area about a vehicle;
an infrared sensor configured to detect an object at a location within the area; and
a display configured to display an image of the area and highlight a portion of the display corresponding to the location when the object is detected.

2. The system in accordance with claim 1, wherein the infrared sensor comprises a plurality of infrared detectors arranged to detect objects at a plurality of distinct locations within the area.

3. The system in accordance with claim 2, wherein the infrared detectors are thermopile detectors.

4. The system in accordance with claim 2, wherein the infrared sensor comprises a first row of a first number of infrared detectors configured to detect objects less than a first distance from the camera, and a second row of a second number of infrared detectors less than the first number of infrared detectors, said second row of infrared detectors configured to detect objects less a second distance from the camera and greater than the first distance from the camera.

5. The system in accordance with claim 2, wherein the plurality of infrared detectors are arranged to form a plurality of infrared sensor modules comprising infrared detectors arranged in planar arrays, and the plurality of infrared sensor modules are arranged in a non-parallel arrangement.

6. The system in accordance with claim 2, wherein one or more of the plurality of infrared detectors are hexagonal in shape.

7. The system in accordance with claim 1, said system further comprising a detection indicator, wherein the detection indicator is activated when the object is detected by the infrared sensor.

8. The system in accordance with claim 7, said detection indicator comprises an audible alarm.

9. The system in accordance with claim 7, said detection indicator comprises a visual indicator.

10. A controller for a vehicle camera system, said controller configured to:
receive a camera signal from a camera configured to view an area about a vehicle;
receive an infrared sensor signal from an infrared sensor configured to detect an object at a location within the area; and
output a display signal to a vehicle operator display, said display signal indicative of an image of the area and highlighting a portion of the display corresponding to the location when the object is detected.

11. A method for displaying an image from a vehicle camera, said method comprising:
receiving a camera signal from a camera configured to view an area about a vehicle;
displaying an image of the area about the vehicle on a display;
receiving an infrared sensor signal from an infrared sensor configured to detect an object at a location within the area; and
highlighting a portion of the display corresponding to the location when the object is detected.

12. The method in accordance with claim 11, said method further comprising the step of activating a detection indicator to further indicate the object being detected by the infrared sensor.
